(19) United States
(12) Patent Application Publication
(10) Pub. No.: US 2005/0266993 A1
(43) Pub. Date: Dec. 1, 2005

(54) Recording and reproducing apparatus and recording and reproducing method

(75) Inventor: Kosuke Haruki, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/137,353

(22) Filed: May 26, 2005

(30) Foreign Application Priority Data
May 28, 2004 (JP) 2004-159718

(51) Int. Cl. B41M 5/20

(52) U.S. Cl. 503/209

(57) ABSTRACT

A recording and reproducing apparatus has a tuner unit channel-selects and decodes a broadcast signal and outputs picture information, a recording unit records the picture information, a reservation image recording management unit stores given day of the week information, time information, channel selection information, and continuous mode information for repeatedly carrying out reservation image recording with respect to these items of information and handling image recording information as a series of information, and which controls the tuner unit and the recording unit based on these items of information, thereby carrying out reservation image recording, and a library generating unit generates display information to display an image as a unit of management information even with respect to management information for plural rounds of image recording information when management information for the image recording information recorded on the continuous mode information is displayed as library information.

### CROSS-REFERENCE TO RELATED APPLICATIONS

This application is based upon and claims the benefit of priority from prior Japanese Patent Application No. 2004-159718, filed May 28, 2004, the entire contents of which are incorporated herein by reference.

### BACKGROUND OF THE INVENTION

The present invention relates to a recording and reproducing apparatus such as a hard disk recorder for carrying out a reservation image recording, for example, and more particularly, to a recording and reproducing apparatus and a recording and reproducing method for making a library screen display of image recording information during repeating reservation image recording of a continuous drama or the like.

Recently, a recording and reproducing apparatus such as a hard disk recorder is being popular with the prevalence of digital equipment, and an access to recording information can be provided more easily than a case of a recording and reproducing process using an earlier VTR (Video Tape Recorder). In such a recording and reproducing apparatus, a reservation image recording process can be carried out, and unattended image recording can be automatically carried out by providing a specified date or day of the week, date and time, channel selection information and the like. In particular, in such a recording and reproducing apparatus such as a hard disk recorder, if a large amount of reservation image recording becomes easy, picture information is recorded as an image as long as a hard disk capacity permits. As a result, since a large amount of image recording information becomes full in a storage region, there is a demand for simply managing image recording information. In contrast, a title sort process or the like is known as a method for sorting management information for image recording information.

In Patent Document 1 (Jpn. Pat. Appln. KOKAI Publication No. 2001-266457), a recording and reproducing apparatus is provided to rearrange such management information for image recording information based on a recorded information attribute, for example, the day of the week, recording start time and the like. In this manner, in particular, a user can recognize how plural items of image recording information on a continuous drama or the like are continuously recorded as an image.

In the above-described prior art, plural items of management information on an image recording information basis are subjected to a sort process in a list, and the display sequence is changed, thereby producing a screen which is comparatively visible to the user. Therefore, for example, if image recording for eight times is present with respect to continuous drama A, eight lines contained in a management table are used, and if image recording for six times is present with respect to continuous drama B, six lines contained in the management table are further used. Compression effect of the management table cannot be desired at all. Therefore, there is a problem that this method cannot be considered to be a convenient display method for a use environment for a large amount of image recording in which some tens to some hundreds of contents are handled. In addition, in the general user's sense, in a situation in which a large amount of image recording information is present, it is more desirable to recognize a library on a contents by contents basis than to recognize a library on an image recording by recording basis. However, there is a problem that a library function of the recording and reproducing apparatus according to a prior art is incompatible with such a recognizing method.

### BRIEF SUMMARY OF THE INVENTION

A recording and reproducing apparatus according to one aspect of the present invention comprises: a tuner unit configured to select channel and decode a broadcast signal and output picture information; a recording unit configured to record the picture information from the tuner unit into a recording region; a reservation image recording management unit configured to store given day of the week information, time information, channel selection information, and continuous mode information for repeatedly carrying out reservation image recording with respect to these items of information and handling image recording information as a series of information, and to control the tuner unit and recording unit based on these items of information, thereby carrying out reservation image recording; and a library generating unit configured to generate display information so as to display an image as a unit of management information even with respect to management information for plural rounds of image recording information when the management information for the image recording information recorded based on the continuous mode information is displayed as library information.

### BRIEF DESCRIPTION OF THE SEVERAL VIEWS OF THE DRAWING

FIG. 1 is a block diagram depicting an example of a configuration of a recording and reproducing apparatus according to one embodiment of the present invention;

FIG. 2 is an illustrative view illustrating an example of an image recording reservation screen of the recording and reproducing apparatus according to one embodiment of the invention;

FIG. 3 is an illustrative view illustrating an example of a library screen (compatible with an additional description mode) of the recording and reproducing apparatus according to one embodiment of the invention;

FIG. 4 is an illustrative view illustrating an example of a library screen (incompatible with an additional description mode) of the recording and reproducing apparatus according to one embodiment of the invention;

FIG. 5 is an illustrative view illustrating an example of a library screen (title sort which is incompatible with an additional description mode) of the recording and reproducing apparatus according to one embodiment of the invention;

FIG. 6 is an illustrative view illustrating an example of a play list screen (chapter point insertion) of the library screen (compatible with an additional description mode) of the recording and reproducing apparatus according to one embodiment of the invention;

FIG. 7 is an illustrative view depicting an example of a play list screen (“viewed” or “non-viewed” display) of the library screen (compatible with an additional description mode) of the recording and reproducing apparatus according to one embodiment of the invention;

FIG. 8 is a flow chart showing an example of a display process of the library screen (compatible with an additional description mode) of the recording and reproducing apparatus according to one embodiment of the invention;

FIG. 9 is a flow chart showing another example (mode integrating function) of a display process of the library screen (compatible with an additional description mode) of the recording and reproducing apparatus according to one embodiment of the invention; and

FIG. 10 is a flow chart showing an example of a reproducing process to be carried out from the library screen (compatible with an additional description mode) of the recording and reproducing apparatus according to one embodiment of the invention.

### DETAILED DESCRIPTION OF THE INVENTION

Hereinafter, preferred embodiments of the present invention will be described with reference to the accompanying drawings.

In a recording and reproducing apparatus according to one embodiment of the present invention, an “additional description mode” is proposed for image recording of a video title. The additional description mode (continuous mode) quite literally denotes an image recording mode for repeatedly additionally describing a title recorded as an image, thereby carrying out image recording. For example, this mode is compatible with a repeating reservation image recording process of a continuous drama or the like.

In the case of considering a scene for utilizing a video recorder, if image recording of a drama or the like is repeatedly carried out every week, the number of titles increases every time such image recording is carried out in a conventional video recorder. Thus, a large number of titles are displayed on a library screen or the like, and a number of pages must be referenced when an image recording state is checked. Therefore, usability becomes very worsened. In contrast, in a recording and reproducing apparatus according to one embodiment of the present invention, by proposing an image recording mode called an “additional description mode”, a very simple library display is made possible, and a further reproducing process can be easily carried out. In addition, in the case where an attempt is made to cancel such an additional description mode, it becomes easier to return to a similar library display by changing the additional description mode to a normal mode and selecting it.

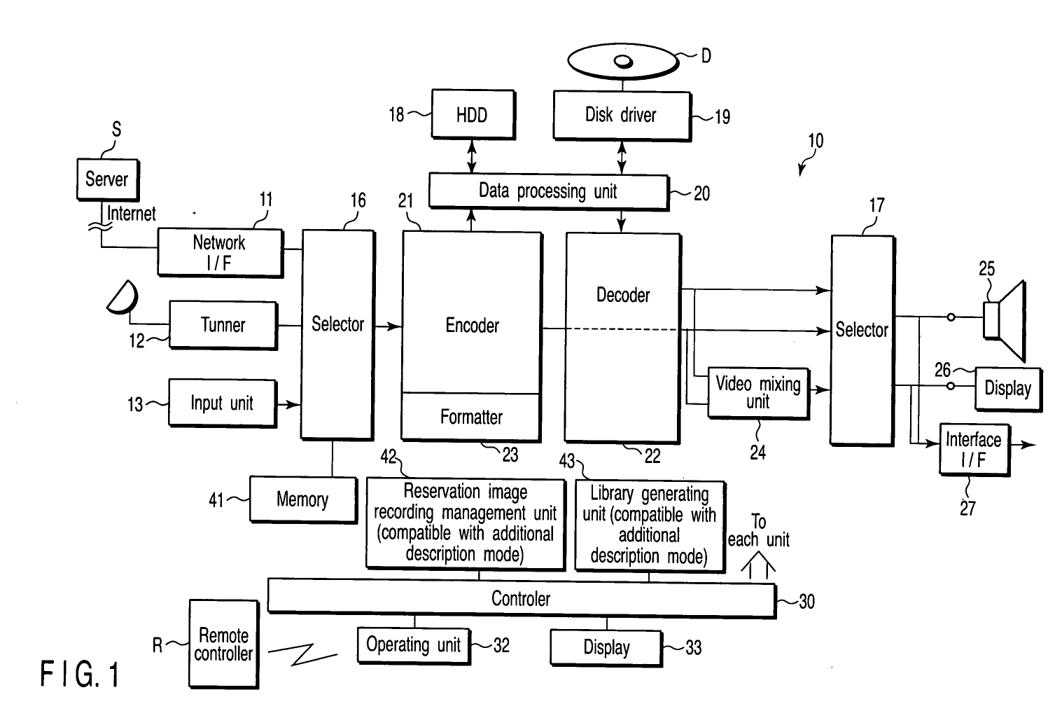

The recording and reproducing apparatus according to the present invention will be described below in more detail by way of example of a recording and reproducing apparatus 10 which is a composite recording and reproducing apparatus as shown in FIG. 1.

<Recording and Reproducing Apparatus According to One Embodiment of the Present Invention>

First, a configuration of the recording and reproducing apparatus according to the invention will be described with reference to the accompanying drawings. FIG. 1 is a block diagram depicting an example of the configuration of the recording and reproducing apparatus according to one embodiment of the invention.

(Configuration)

Although the present embodiment presents that a recording medium can be handled as both of a DVD-RAM and a hard disk as a recording medium, such a hard disk or DVD-RAM may be replaced with a recording medium using a semiconductor memory or the like. The blocks of FIG. 1 are roughly divided into a main block of a recording unit shown at the left side and a main block of a reproducing unit shown at the right side.

The recording and reproducing apparatus 10 of FIG. 1 has two types of disk drive units. First, this apparatus has a disk driver 19 for executing information reading and writing by rotationally driving an optical disk D as a first medium which is an information recording medium capable of constructing a video file. In addition, this apparatus has a hard disk drive unit 18 for driving a hard disk as a second medium. A controller 30 is connected to each unit in order to control a whole operation. For example, recorded data can be supplied to the disk driver 19 and the hard disk drive unit 18 and a reproduced signal can be received there. The controller 30 handles data on a recording or reproduction basis and includes a buffer circuit, an error correcting unit and the like.

The recording and reproducing apparatus 10 of FIG. 1 primarily comprises: an encoder 21 which configures an image recording side; a decoder 22 which configures a reproducing side; and the controller 30 which controls an operation of an apparatus main body. The recording and reproducing apparatus 10 has an input side selector 16 and an output side selector 17. A network interface (I/F) 11, a tuner 12, and an input unit 13 are connected to the input side selector 16, and a signal is outputted to the encoder 21 or a memory 41. In addition, the recording and reproducing apparatus 10 has: a formatter 23 to be connected to the encoder 21; a data processing unit 20 which receives an output of the encoder 21; a hard disk driver 18 to be connected to the data processing unit 20; and an optical disk driver 19. Further, the recording and reproducing apparatus 10 has: a decoder 22 which receives and decodes a signal from the hard disk driver 18 or the optical disk driver 19; and a video mixing unit 24 which receives an operating signal from the encoder 21, the decoder 22, the controller 30, and a display unit 31. Furthermore, an output of the selector 17 is connected to an external speaker unit 25 and a display unit 26 or is supplied to an external device via an interface 27 which makes communication with the external device. Moreover, the recording and reproducing apparatus 10 has an operating unit 32 connected to the controller 30, the operating unit receiving an operation of the user's operation or an operation of a remote controller R. Similarly, the recording and reproducing apparatus 10 has a display 33 connected to controller, and displaying the operation information and so on.

The remote controller used here enables operation which is substantially identical to the operating unit 32 provided at the main body of the recording and reproducing apparatus 10. This remote controller enables a variety of settings such as a recording and reproducing command of the hard disk driver 18 or disk driver 19, an edit command, a tuner operation, or reservation image recording setting. Furthermore, the recording and reproducing apparatus 10 has: the memory 41 which receives an output such as an image signal of the selector 16 and stores the output therein; a reservation image recording management unit 42 which manages reservation information and executes reservation image recording; and a library generating unit 43 which produces and manages library information which is management information according to image recording information or the like stored by reservation image recording, normal image recording or the like.

(Basic Operation)

A reproducing process and a recording process in the recording and reproducing apparatus having such a configuration will be briefly described by way of example of an optical disk. The process of reproducing the optical disk is carried out as follows. That is, under the control of the controller 30, in an optical disk D rotated at a predetermined speed by a disk motor 63 controlled by a disk motor driver 64, the laser light driven by a laser driver 65 is irradiated, its reflection light is detected by means of a photo detector 52 of an optical pickup 51, and a detection signal S based on the detected light is outputted. This detection signal S is supplied to an RF amplifier included in the data processing unit 20. An RF signal outputted from this amplifier is supplied to the decoder 22 and the controller 30. In addition, a focus error signal and a tracking error signal which are servo signals generated by the RF amplifier included in the data processing unit 20 are supplied to a focus control unit and a tracking control unit 62, respectively. The data processing unit 20 decodes the RF signal, and the decoded signal is mixed by the video mixing unit 24 or is externally outputted as it is via the interface 27. In addition, the controller 30 produces a control signal for controlling a rotation of the disk motor 63 and supplies the signal to the disk motor driver 64, thereby controlling the rotation of the disk motor 63.

Further, in the recording and reproducing apparatus having such a configuration, an optical disk recording process is carried out as follows. That is, under the control of the controller 30, for example, the data supplied via the input unit 13 and the selector 16 is supplied to the encoder 21 after being stored in the memory 41. The supplied data is encoded and outputted. According to this encoded output and the output of the controller 30, a drive current of the laser driver 65 is supplied to the optical pickup 51. The optical pickup 51 emits the laser light according to this drive current from an incorporated laser diode 54, and irradiates the laser light to a storage region of the optical disk D rotated by a predetermined rotation frequency by means of the disk motor 63, whereby the recording process is carried out.

(Detailed Operation)

Recording Process or the Like

Now, an operation of the recording and reproducing apparatus 10 having such a configuration will be described in more detail. First, operations during recording including those according to other embodiments will be primarily described in detail. As an input side of the recording and reproducing apparatus 10, the network I/F 11 makes connection to a server S or the like via the Internet or the like, for example, and downloads contents information or the like. The tuner 12 selects a broadcast signal via an antenna, and outputs a picture signal and a voice signal. This tuner unit is compatible with various types of broadcasting including terrestrial wave analog broadcasting, terrestrial wave digital broadcasting, BS analog broadcasting, BS digital broadcasting, CS digital broadcasting and the like, without being limited thereto. In addition, in view of marketability, it is preferable that two or three or more tuner units for analog broadcasting be provided instead of providing only one tuner unit so as to be functioned in parallel in response to a request for reservation image recording.

Further, the input unit 13 receives a luminance signal and a color difference signal, composite picture signal, and a voice signal from the outside. These signals are selectively supplied to the encoder 21 after an input has been controlled by the selector 16 controlled by the controller 30 or the like. That is, to the encoder 21, an external analog video signal and an external analog audio signal from the input unit 13 or an analog video signal and an analog audio signal from the TV tuner 12 are inputted via the selector 16.

The encoder 21 has: video and audio analog digital converters for digitizing an analog video signal and an analog audio signal inputted by the selector 16; a video encoder; and an audio encoder. This encoder unit also includes a subsidiary picture encoder. An output of the encoder 21 is converted into a predetermined DVD-RAM format at the formatter 23 including a buffer memory, and the converted output is supplied to the controller 30 described previously.

When a directly compressed digital video signal or digital audio signal is directly inputted, the encoder 21 can supply the compressed digital video signal or digital audio signal directly to the formatter 23. The encoder 21 can also supply an analogously or digitally converted digital video signal or audio signal directly to the video mixing unit 24 or the selector 17.

In the video encoder included in the encoder 21, a digital video signal is converted into a digital video signal compressed at a variable bit rate in accordance with an MPEG2 or MPEG1 standard. A digital audio signal is converted into a digital audio signal compressed at a fixed bit rate in accordance with an MPEG or AC-3 standard or a digital audio signal of linear PCM.

In the case where a subsidiary picture signal has been inputted from the input unit 13 or in the case where a DVD video signal having such a data configuration has been broadcast and received by the TV tuner 12, the subsidiary picture signal included in a DVD video signal is encoded (run length encoded) by the subsidiary picture encoder, and a subsidiary picture bit map is produced.

The encoded digital video signal, digital audio signal, and subsidiary picture data are packed at the formatter 23, and these packed signals and data are provided as a video pack, an audio pack, and a subsidiary picture pack. Further, these packs are collected and converted into a format defined in accordance with a DVD-recording standard (for example, a standard to be recorded in a DVD-RAM, DVD-R, DVD-RW and the like).

The apparatus of FIG. 1 can supply information formatted by the formatter 23 (a pack of video, audio, and subsidiary picture data) and produced management information to the hard disk drive unit 18 or the disk driver 19 via the controller 30 and can record them in the hard disk unit 18 or the optical disk D. In addition, the information recorded in the hard disk unit 18 or the optical disk D can be recorded in the optical disk D or the hard disk unit 18 via the controller 30 or the disk driver 19.

In addition, according to the above-described reservation image recording management unit 42 and the library generating unit 43, reservation image recording is carried out based on reservation information inputted from the remote controller R or operating unit 32, or alternatively, EPG (Electronic Program Guide) information captured via the tuner 12 or the network I/F 11, or alternatively, the library information according to image recording information stored from reservation image recording or the like is generated and managed by the library generating unit 43.

Edit Process or the Like

Now, a process of editing recorded information including that according to other embodiments will be described in detail. The edit process for partially deleting video objects of a plurality of programs recorded in the hard disk unit 18 or connecting objects of different programs to each other can be carried out.

The controller 30 includes: an MPU (micro-processing unit or a CPU (central processing unit); a ROM having a control program or the like written therein; and a RAM for providing a work area required for executing a program, in order to facilitate the edit process.

It is preferable that the MPU of the controller 30 use a RAM as a work area in accordance with the control program stored in its ROM, thereby determining a readout or write address in the hard disk driver 19 or providing fault location detection, unrecorded region detection, image recording information recording position setting, UDF recording, AV address setting and the like.

In addition, it is preferable that the controller 30 further comprise: a directory detecting unit and a management information control unit during editing and image recording, although not shown; a VMG (whole video management information) information producing section; a copy related information sensor unit; a copy and scrambling information processing unit (RDI processing unit); a packet header processing unit; a sequence header processing unit; and an aspect ratio information processing unit, according to a still another embodiment.

During an edit process or during another process, from among the MPU execution result, the contents which should be notified to a user are displayed on the display unit 31 of the recording and reproducing apparatus or are OSD (audio screen display) displayed on the display 26. The controller 30 has an operating unit 32 which provides an operating signal for operating this apparatus. It is preferable that the operating unit 32 be equipped with the remote controller R.

An operation of a timing for the controller 30 to control the disk driver 19, the hard disk drive unit 18, the controller 30, the encoder 21 and/or the decoder 22 can be executed based on time data from an STC (system time clock), although not shown. Although an image recording or reproducing operation is generally executed in synchronism with a time clock from the STC, the other processes may be executed at a timing which is independent of the STC.

Reproducing Process or the Like

Now, a process of reproducing recorded information including that according to other embodiments will be primarily described in detail. The decoder 22 comprises: a separator which separates and takes out each pack from a DVD format signal having a pack structure; a memory to be used during pack separation or other signal processing execution; a V decoder which decodes main picture data (contents of a video pack) separated by the separator; an SP decoder which decodes subsidiary picture data (contents of a subsidiary picture pack) separated by the separator; and an AV decoder which decodes audio data (contents of an audio pack) separated by the separator. In addition, this decoder unit comprises a video processor which properly combines the decoded subsidiary picture with the decoded main picture and which outputs a menu, a highlight button, subtitles or any other subsidiary picture to be superimposed on a main picture.

An output video signal of the decoder 22 is inputted to the video mixing unit 24. Mixing of text data is carried out at the video mixing unit 24. A line for directly acquiring a signal from the TV tuner 12 or the input unit 13 is also connected to the video mixing unit 24. A frame memory (not shown) used as a buffer is connected to the video mixing unit 24. When an output of the video mixing unit 24 is supplied to the selector 17, and then, the supplied output is selected by the selector 17, the selected output is supplied to the display 26, and then, is displayed there, or alternatively, is supplied to an external device via the I/F (interface) 27.

An output audio signal of the decoder 22 is supplied to the speaker 25 after being analogously converted by a digital to analog converter (not shown) via the selector 17, or alternatively, is supplied to the external device via the I/F 27. The selector 17 is controlled by a select signal from the controller 30. In this manner, when the selector 17 directly monitors a digital signal from the TV tuner 12 or the input unit 13, it is possible to directly select a signal passing through the encoder 21.

The formatter 23 of the encoder 21 produces each item of isolation information during image recording and periodically sends the information (information produced during GOP head interruption or the like) to the MPU of the controller 30. The isolation information includes the number of VOBU packs, an end address of I picture from the head of VOBU, VOBU reproduction time, and the like.

At the same time, information from an aspect information processing unit is sent to the MPU when image recording starts, and the MPU produces VOB stream information (STI). The STI used here stores resolution data, aspect data and the like. During reproduction, based on this information, initial settings are provided at each decoder unit.

The controller 30 receives data in units of VOBU from the formatter 23 of the encoder 21, and supplies the data to the disk driver 19 or the hard disk drive unit 18. When the MPU of the controller 30 produces management information required for reproducing the recorded data, and then, recognizes a recording end command, the MPU sends the produced management information to the controller 30. In this manner, the management information is recorded in the disk. Therefore, when encoding is carried out, the MPU of the controller 30 receives information (such as isolation information) on a data by data basis from the encoder 21. In addition, the MPU of the controller 30 recognizes management information (file system) read from the optical disk D and the hard disk unit 18 when recording starts; recognizes an unrecorded area of each disk; and sets a recorded area on the data in the optical disk D via the controller 30.

Furthermore, the controller 30, as described later, for example, can provide an access to the server S including the contents information provided over the Internet via the network I/F 11, download the contents information, and record it in a storage region of the hard disk drive unit 18. The contents information recorded in the storage region of the hard disk drive unit 18 is read out from the hard disk drive unit 18 in response to the user's operation, and the read-out information is properly selected by the selector 17 via the video mixing unit 24 after decoded by the decoder 22. The selected information is supplied to an external device via the speaker unit 25 and the display 26 or I/F 27.

The recording and reproducing apparatus 10 according to the present embodiment has comprehensive functions, as described above, and carries out a recording and reproducing process using the hard disk unit 18 (or optical disk D) for a plenty of sources. Now, a reservation image recording process of a broadcast signal primarily utilizing the hard disk unit 18 and a library display process of image recording information after image recorded will be described below in detail.

<Reservation Image Recording Process and Library Display Process>

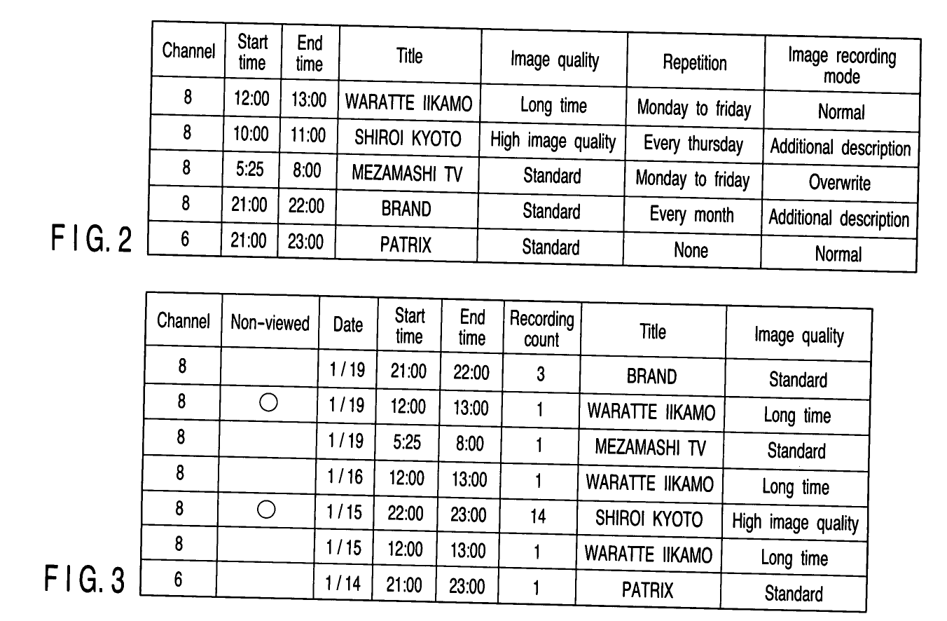

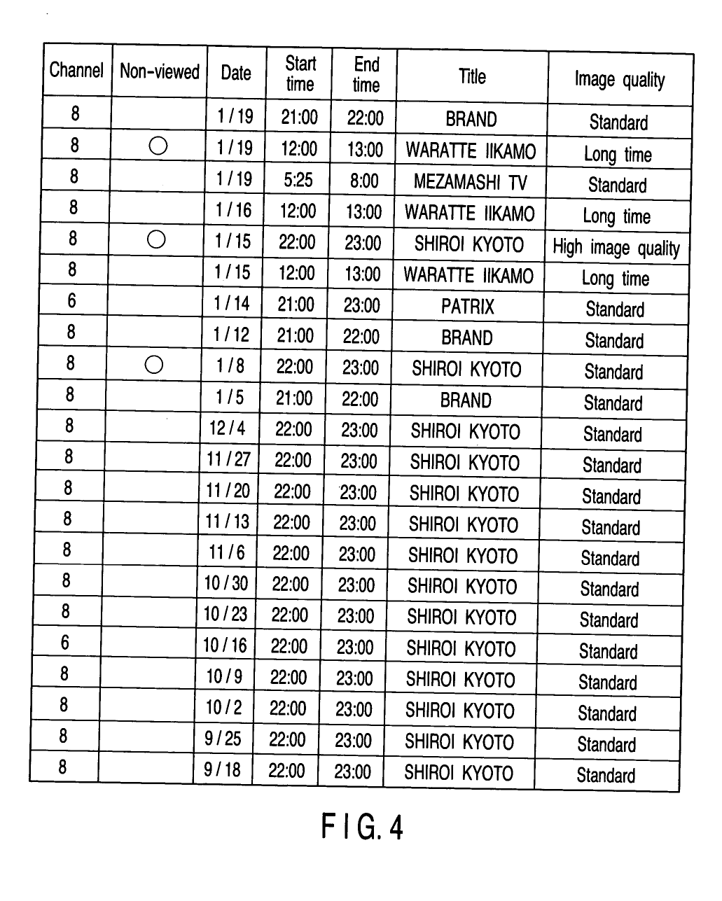

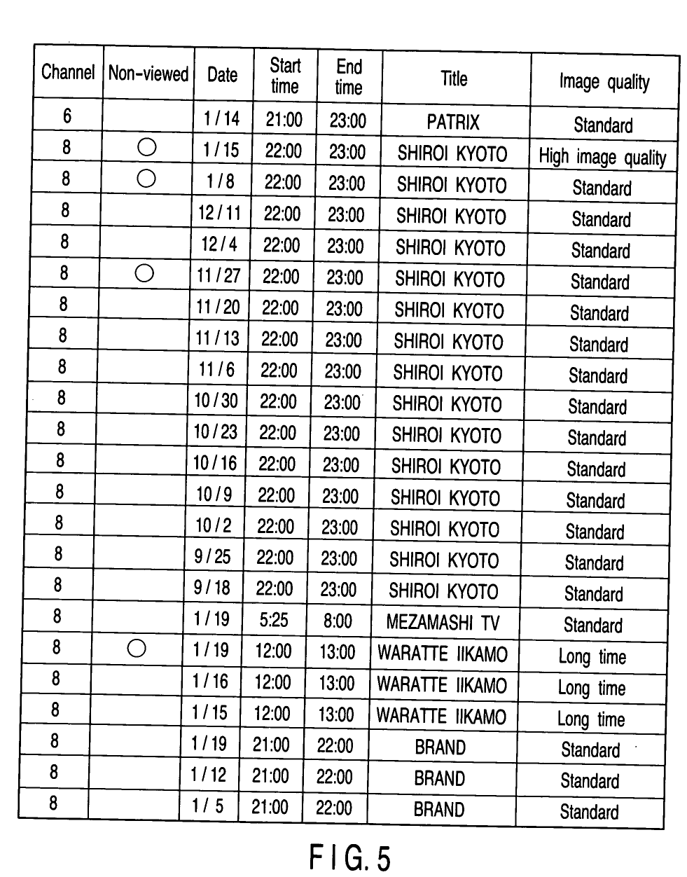

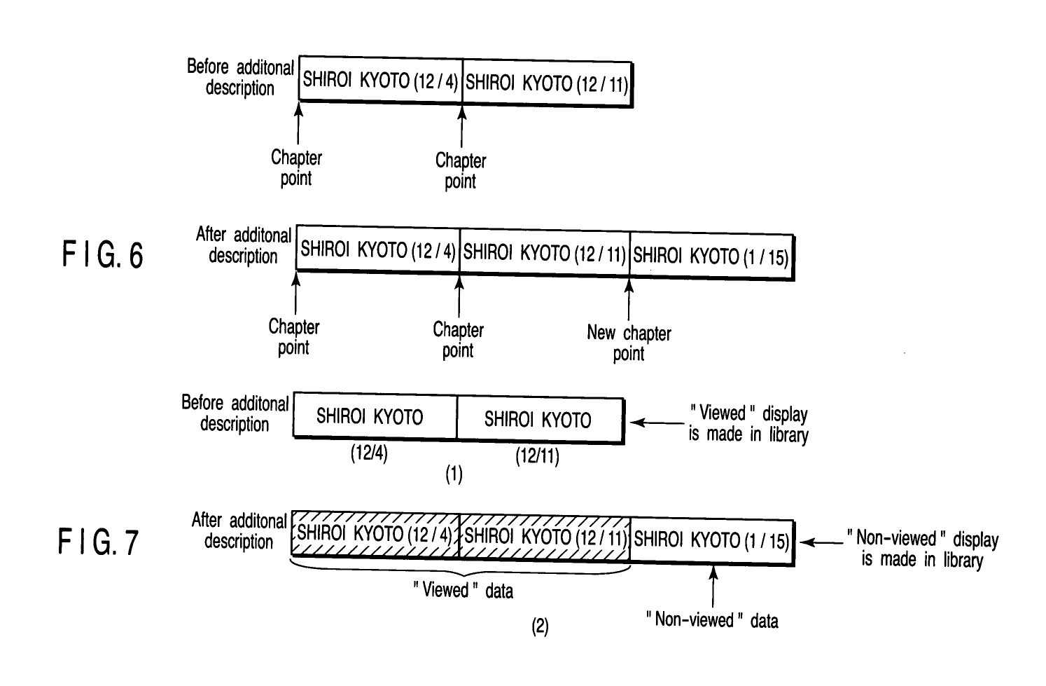

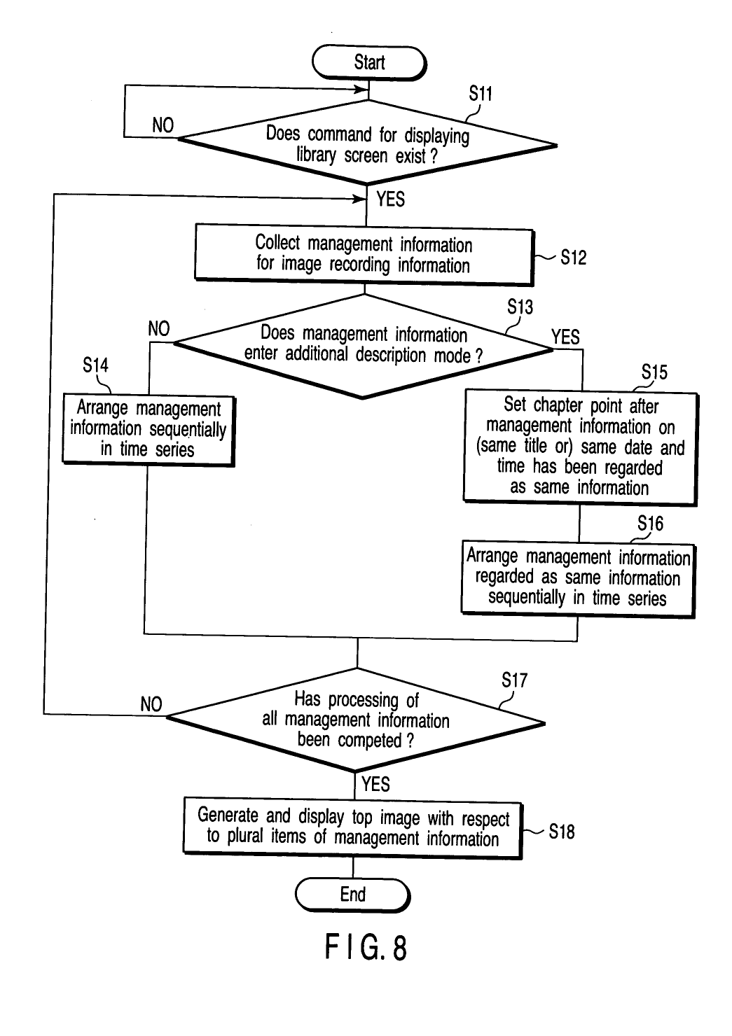

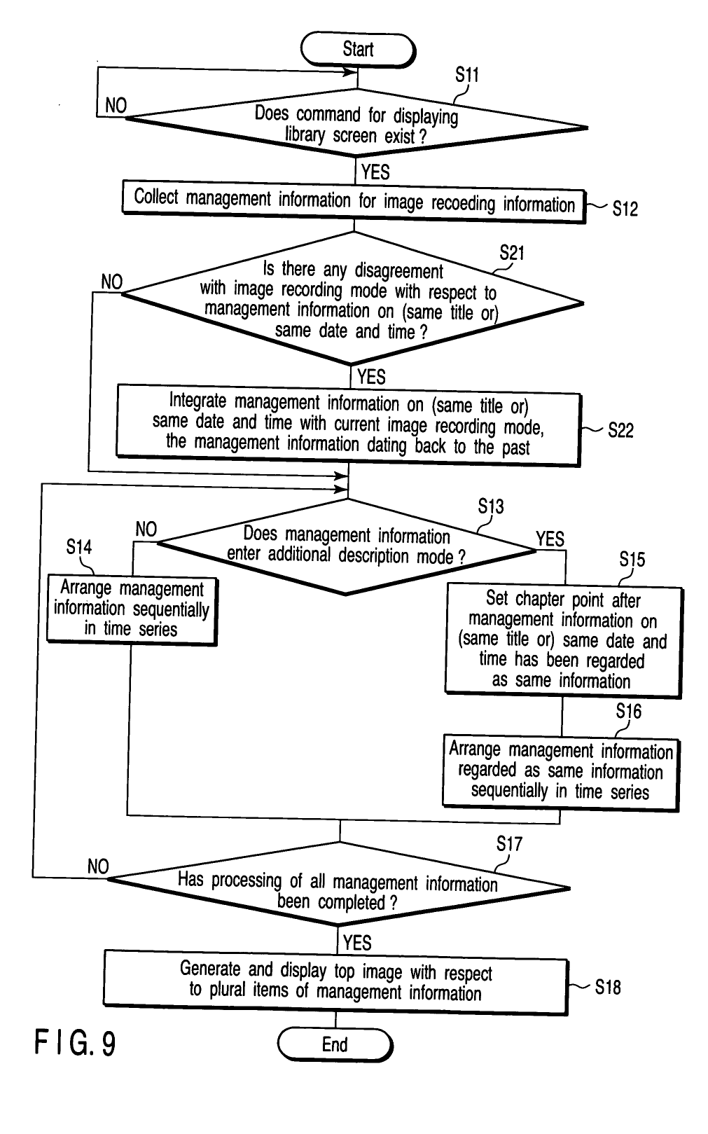

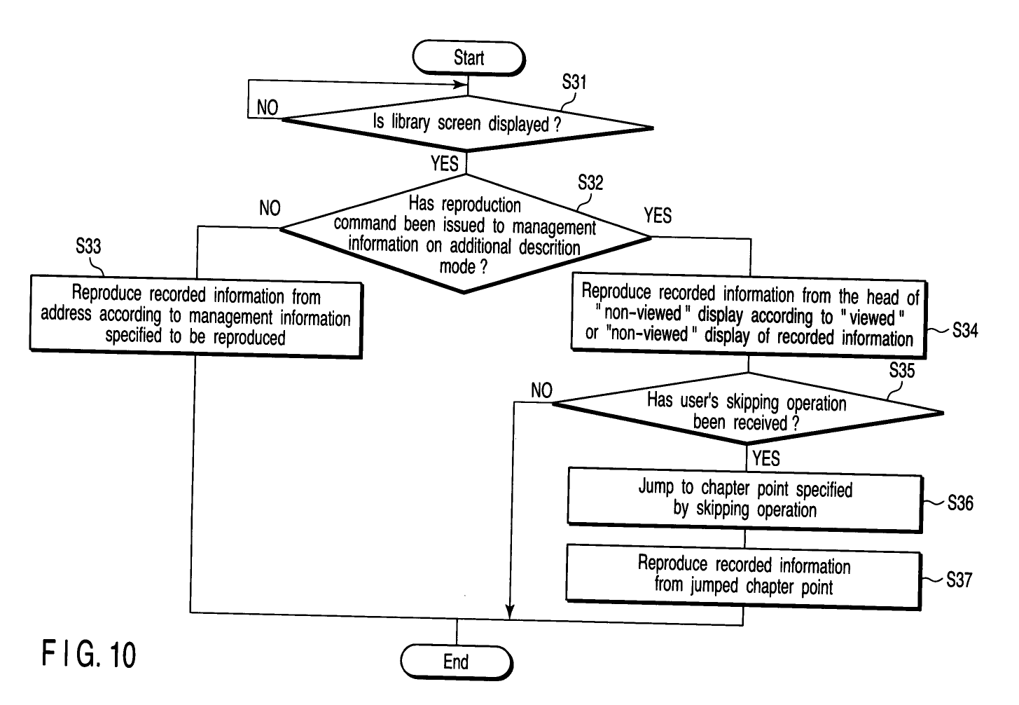

FIG. 2 is an illustrative view illustrating an example of an image recording reservation screen of the recording and reproducing apparatus according to one embodiment of the present invention. FIG. 3 is an illustrative view illustrating an example of a library screen (compatible with an additional description mode) of the recording and reproducing apparatus. FIG. 4 is an illustrative view illustrating an example of a library screen (incompatible with an additional description mode) of the recording and reproducing apparatus. FIG. 5 is an illustrative view illustrating an example of a library screen (title sort which is incompatible with an additional description mode) of the recording and reproducing apparatus. FIG. 6 is an illustrative view illustrating an example of a play list screen (chapter point insertion) of the library screen (compatible with an additional description mode) of the recording and reproducing apparatus. FIG. 7 is an illustrative view depicting an example of a play list screen (“viewed” or “non-viewed” display) of the library screen (compatible with an additional description mode) of the recording and reproducing apparatus. FIG. 8 is a flow chart showing an example of a display process of the library screen (compatible with an additional description mode) of the recording and reproducing apparatus. FIG. 9 is a flow chart showing another example (mode integrating function) of a display process of the library screen (compatible with an additional description mode) of the recording and reproducing apparatus. FIG. 10 is a flow chart showing an example of a reproducing process to be carried out from the library screen (compatible with an additional description mode) of the recording and reproducing apparatus.

The recording and reproducing apparatus according to one embodiment of the present invention is provided as a composite type recording and reproducing apparatus having an image recording function, a reproducing function, an editing function and the like, as described above. A reservation image recording process is carried out in accordance with the following procedures. Further, library information according to image recording information using reservation image recording or the like is generated and utilized.

Reservation Image Recording Process

A reservation image recording process is carried out based on image recording reservation information according to input information supplied from the user via the operating unit 32 or remote controller R or based on EPG (Electronic Program Guide) information captured via the tuner 12 or network I/F 11. In the case where the above process is carried out via the operating unit 32 or remote controller R, parameters such as image recording month and day (or the day of the week such as every Friday or every Monday to Friday), broadcast channel, start time and end time, image quality such as “long time, high image quality, and standard”, and image recording mode such as “normal mode, overwrite mode, and additional description mode are inputted. Further, it is preferable that a title or any other additional information be inputted to the user.

In addition, a broadcast program table is displayed on a television screen or the like by the EPG captured via the tuner 12 and the network I/F 11, and a desired program is specified by a cursor or the like, thereby making it possible to carry out image recording reservation. At this time, it becomes possible to easily capture additional information such as a title in a storage region of the reservation image recording management unit 42. FIG. 2 shows an image recording reservation screen produced based on the EPG information captured via an analog terrestrial wave tuner included in the tuner 12. Here, an “additional description mode” (continuous mode) according to one embodiment of the present invention is set for image recording reservation of a title “SHIROI KYOTO” and a title “BRAND”.

This “additional description mode” (continuous mode) is provided as an image recording mode used for reservation image recording of a continuous drama or the like, for example, the image recording mode being adopted to display a unit of management information according to plural items of image recording information during library production described later. That is, this image recording mode is used for image recording reservation to be repeatedly image recorded such as, for example, every Thursday, channel 8, and 10:00 to 11:00 at night.

According to such image recording reservation information, under the control of the controller 30 and the reservation image recording management unit 42, for example, the tuner 12 channel-selects and reproduces a desired broadcast signal, and then, the channel-selected signal is repeatedly recorded as an image in a predetermined storage region of the hard disk driver 18.

Library Display Process

Now, with respect to the image recording information (including manually image recorded information) reserved and recorded described above, in response to a user's command from the operating unit 32 or the like, a library display process is carried out as shown in FIG. 8 by working of the controller 30 and the library generating unit 43. That is, when the user's command is supplied to display the library screen via the operating unit 32 or the like (S11), the library generating unit 43 makes a search for the storage region of the reservation image recording management unit 42 or the hard disk driver 18 under the control of the controller 30, thereby collecting management information for the image recording information stored in a storage region of the current hard disk driver 18 or the like (S12). Then, it is point by point determined whether or not the management information for all the image recording information enters the additional description mode. If the management information is not image recording information recorded in accordance with the additional description mode, all plural items of management information are arranged sequentially, for example, in time series (S17). For example, image information corresponding to the library screen display as shown in FIG. 3 is generated, and the generated information is supplied to, for example, the video mixing unit 24 (S18).

On the other hand, when the management information indicates that image recording information has been recorded in the additional description mode (S13), management information on (the same title) or same date and time channel is regarded as the same information, and a chapter point is set for continuous image recording information (S15). Then, the items of management information recorded as the same information are rearranged sequentially in time series (S16). These processes may be carried out at a time point at which reservation image recording has started and ended according to reservation information or may be carried out at a time point at which the user has commanded library screen display. After these processes have been completed for all the management information (S17), the library generating unit 43, for example, generates image information in order to display the library screen as shown in FIG. 3 on the display 26 or the like, and, for example, supplies this information to the video mixing unit 24.

Now, the library screen corresponding to the “additional description mode” (continuous mode) shown in FIG. 3 will be described here. The library screen displays a channel, a viewed or non-viewed mode, a date, a start and end time, a title and an image quality, and the number of recorded images. Further, the “additional description mode” (continuous mode) is set for, for example, the title “BRAND” or the title “SHIROI KYOTO”. Therefore, although three recorded images or 14 recorded images are present, a unit of management information is merely displayed. The “number of recorded images” indicates that, although a unit of information is displayed for the title “BRAND” or the title “SHIROI KYOTO”, three recorded images or 14 recorded images are present.

It is found that the library screen corresponding to such an “additional description mode” (continuous mode) is produced, whereby the library screen becomes dramatically short and brief, and is the best display format to the user.

FIG. 3 shows an example of a viewed or non-viewed display method on the library screen. If all the recorded information corresponding to a unit of management information is “viewed”, the corresponding “non viewed” mark is not displayed. When even part of the recorded information corresponding to a unit of management includes “non-viewed” image information, although it is preferable that the “non-viewed” mark be displayed as shown in FIG. 3, another expression method may be used.

Advantageous Effect of Library Screen Display in Accordance with Additional Description Mode

The function and advantageous effect of the library screen corresponding to this “additional description mode” (continuous mode) can be understood by comparing the library screen with the following display. FIG. 4 merely shows management information for image recording information in time series with respect to a library screen which does not correspond to the additional description mode. Here, management information on a plurality of programs is indicated at random, and a redundant library screen, the entirety of which is hardly grasped, is produced. The length used here is twice or more of that shown in FIG. 3.

Now, let us consider a case where a library screen is displayed in a sorted manner on a title name basis, as shown in FIG. 5. In this case, although the screen is slightly easily visible, a total number of titles is not changed as compared with the case of FIG. 4. Thus, reduction effect is not desired, making it impossible to display the titles on a single screen of the display 26.

In the case where an attempt is made to check which drama is “non-viewed”, the screen is still hardly visible. Further, in view of an aspect of packaging, a limited total number of titles can be displayed. Thus, it is wasteful on display to wastefully occupy title indexes with the same title.

In addition, as the user's manual edit process, as in the above-described additional description mode, it is possible to collect one item of image recording data on the same titles by carrying out play list editing or the like. However, even the play list editing becomes a complicated operation for users who utilize a video recorder only for broadcast check of a drama or the like. Thus, the “library display in accordance with additional description mode (continuous mode)” according to one embodiment of the present invention is advantageous to users in the sense that a redundant complicated library screen is automatically provided as a value-added, simple, and ideal management screen.

That is, for example, in the case where a redundant library screen, on which about 10-round continuous drama or the like has been left to be reserved and recorded by 7 to 8 titles one week, has been redisplayed in the above-described additional description mode, the length of the screen is reduced to about 1/10. Therefore, advantageous effect of the library screen display in accordance with the additional description mode according to one embodiment of the invention is found to be very great.

Mode Integrating Process

Now let us consider how to make a library display of management information for image recording information in the case where image recording is first carried out, for example, four times, in the “normal mode”, and hen, image recording is carried out three times in the “additional description mode” when reservation image recording of a repeating program such as a continuous drama is carried out. In the case of the flow chart shown in FIG. 8, a four-line based display is made for the first four rounds, and a single-unit, i.e., single-line based library display is made for the later three rounds in the additional description mode.

Here, in the process shown in FIG. 9, at a time point at which a current mode has been changed to the additional description mode, management information for image recording information in the normal mode is changed to management information produced in the case where image recording has been made in the additional description mode, the management information dating back to the past, and then, a single-unit, i.e., single-line based display is made.

That is, as shown in FIG. 9, when a library display process is carried out, and then, a command is issued from the user to display a library screen via the operating unit 32 or the like (S11), the library generating unit 43 makes a search for the storage region of the reservation image recording management unit 42 or the hard disk driver 18 under the control of the controller 30, thereby collecting management information for image recording information stored in a storage region of the current hard disk driver 18 or the like (S12).

Then, if there is a disagreement with an image recording mode with respect to management information on (the same title) or the same date and time (such as every day of the week) (S21), such a recording mode is changed to a current image recording mode, i.e., the additional description mode, and the changed mode is integrated with respect to management information on (the same title) or the same date and time (such as every day of the week), the mode dating back to the past (S22). Then, it is point by point determined whether or not the management information for all the image recording information enters the additional description mode (S13). Here, if the management information is not image recording information recorded in accordance with the additional description mode, all of plural items of management information are arranged sequentially, for example, in time series (S17), for example, image information corresponding to the library screen display as shown in FIG. 3 is generated, and for example, the generated image information is supplied to the video mixing unit 24 (S11).

On the other hand, when management information indicates that image recording information has been recorded in the additional description mode (S13), management information on (the same title or) the same date and time channel is regarded as the same information, and then, a chapter point is set for continuous image recording information (S15). Then, plural items of the management information regarded as the same information are rearranged sequentially in time series (S16). These processes may be carried out at a time point at which reservation image recording has started and ended according to reservation information or may be carried out at a time point at which the user has commanded a library screen display. After these processes have been completed with respect to all the management information (S17), the library generating unit 43 produces image information in order to display the library screen as shown in FIG. 3 on the display 26 or the like, and supplies this information to the video mixing unit 24, for example.

Reproducing Process

Now, a process of reproducing image recording information in the additional description mode (continuous mode) on such a library display will be described with reference to FIG. 6 or FIG. 7 and the flow chart of FIG. 10. During the above-described additional description mode (continuous mode), image recording information which is repeatedly recorded is handled as one item of continuous image recording information on management information. As shown in FIG. 6, image recording information on the title “SHIROI KYOTO” is stored again in the reservation image recording management unit 42 or library generating unit 43 as continuous image recording information that is provided with a chapter point. Namely, when newly recorded image recording information is additionally described on the existing image recording information, at least a new charm point, a total recording time, an address, and “viewed” or “non-viewed” information are added to management information, whereby it is regarded that an additional description process has been carried out.

Further, in a state where the library screen of FIG. 3 is displayed on the display 26 or the like, management information on the additional description mode (continuous mode) is selected by the user's operation, whereby “viewed” data and “non-viewed” data are identifiably displayed as shown in (2) of FIG. 7.

Now, a process of reproducing image recording information in the additional description mode (continuous mode) on a library display will be described with reference to the flow chart of FIG. 10. In a state where the library screen is displayed (S31), when the user supplies a reproducing command by, for example, a region specification with the cursor or by double-clicking operation with an Enter key or the like, with respect to management information on the additional description mode (S32), recorded information is reproduced from the head of the “non-viewed” display, according to the “viewed” or “non-viewed” display of the recorded information (S34). An operation in which a so-called resume point is at a start point of a “non-viewed” chapter is produced.

In the middle of this reproduction, if a skipping operation is received from the user via the remote controller R or operating unit 32, a current point jumps to a chapter point specified by the skipping operation according to the chapter point shown in FIG. 6 (S36), and recorded information is reproduced from the jumped chapter point (S37). In addition, in step S32, if management information in the additional description mode is not present, recorded information may be reproduced from an address according to the management information specified to be reproduced, as in normal reproduction (S33).

As has been described above in detail, with the recording and reproducing apparatus according to one embodiment of the present invention, the additional description mode (continuous mode) is newly set to make repetitive reservation image recording of every Thursday, 10 O'clock or the like, and, for example, 10-round image recording information is displayed in a single unit during a library display, thereby making it possible to extremely compress and briefly representing the library display. Assuming a user environment in which, for example, 7 or 8 continuous dramas, periodic programs or the like are used in an always reserved and recorded state as a result of further hard disk price reduction and the achievement of high capacity, whereby image recording information overflows into the hard disk in units of several tens to several hundreds of items, the library display simplified in accordance with the above-described additional description mode (continuous mode) is considered to be indispensable. That is, in such an environment, it is desired that a large amount of recorded information in the hard disk be library-displayed in a single screen mode or a multi-screen mode. For example, management information on the additional description mode (continuous mode) having about 10-round image recording information is compressed to about 1/10, and the compressed management information is displayed on the library screen, thus making it possible to expect extremely high compression display effect.

Although the above-described embodiment has described one embodiment of the present invention in the recording and reproduction apparatus serving as a composite machine including a disk driver unit or the like of an optical disk, it is, of course, possible to carry out a similar process in, for example, a recording and reproducing apparatus which handles only a hard disk driver unit without being limited thereto.

In the above-described embodiment, when reservation image recording is carried out, for example, with respect to a program to be repeatedly recorded such as a continuous drama or a program broadcast every day, the additional description mode (continuous mode) or the like is provided as an image recording mode, thereby carrying out reservation image recording. When management information after image recorded is displayed on the library screen, even if image recording information on the additional description mode (continuous mode) includes, for example, 15 rounds, the information is displayed in one line (in one unit) on the library screen, thereby making it possible to smoothly compress management information for a number of items of image recording information in a hard disk having a high capacity and display the compressed information very easily.

Furthermore, this management information indicated in one line (in one unit) is specified or clicked by the user's operation, for example, 15-round image recording information is selectively displayed together with the “viewed” or “non-viewed” display, thereby enabling further user's easy operation. One skilled in the art can achieve the present invention in accordance with the above-described various embodiments. Further, it is obvious to one skilled in the art to conceive various modifications to these embodiments, and it is possible to apply them to the various embodiments even if one does not have any inventive capacity. Therefore, the present invention encompasses a broad scope without departing from the disclosed principle and novel features, and is not limited to the above-described embodiments.

1. A recording and reproducing apparatus comprising:
a tuner unit configured to select channel, decode a broadcast signal, and output picture information;
a recording unit configured to record the picture information from the tuner unit into a recording region;
a reservation image recording management configured to store given day of the week information, time information, channel selection information, and continuous mode information for repeatedly carrying out reservation image recording with respect to these items of information and handling image recording information as a series of information, and to control the tuner unit and recording unit based on these items of information, thereby carrying out reservation image recording; and
a library generating unit configured to generate display information so as to display an image as a unit of management information even with respect to management information for plural rounds of image recording information when the management information for the image recording information recorded based on the continuous mode information is displayed as library information.

2. A recording and reproducing apparatus according to claim 1, wherein the reservation image recording management unit carries out reservation image recording based on normal mode information which is a normal image recording mode and the continuous mode information, according to reservation information to be inputted, and the library generating unit handles management information for one item of image recording information recorded based on the normal mode information as a unit of management information, in response to a command for displaying a library screen, and generates display information so as to display an image on the same screen as a unit of management information even with respect to management information for plural rounds of image recording information recorded based on the continuous mode information.

3. A recording and reproducing apparatus according to claim 1, wherein the library generating unit displays an image as a unit of management information even with respect to management information for image recording information recorded a plurality of times based on the continuous mode information, in response to a command for displaying a library screen, and generates display information so as to display an image together with image recording count of the image recording information.

4. A recording and reproducing apparatus according to claim 1, wherein, when management information for image recording information recorded based on the continuous mode information is displayed as library information, display information is generated so as to display an image together with whether the image recording information is “viewed” or “non-viewed”.

5. A recording and reproducing apparatus according to claim 1, wherein, while the reservation image recording management unit repeatedly carries out reservation image recording based on same reservation information, when reservation mode information has been changed from the normal mode information to the continuous mode information in the middle of the image recording, the library generating unit changes management information for image recording information after recorded from the normal mode information to the continuous mode information, the management information dating back to the past, and integrates the changed information, thereby generating display information so as to display an image as a unit of management information with respect to management information for plural items of image recording information which have been repeatedly reserved and recorded based on the same reservation information.

6. A recording and reproducing apparatus according to claim 1, wherein the library generating unit manages plural items of image recording information recorded based on the continuous mode information as a series of continuous image recording information, and edits the management information so that a chapter point is set for the series of image recording information every time image recording is carried out.

7. A recording and reproducing apparatus according to claim 1, wherein, on a display screen of library information for image recording information generated by the library generating unit, when management information on the continuous mode is specified by a user operation, display information is generated so that each of plural items of image recording information in accordance with the continuous mode is selectively displayed.

8. A recording and reproducing apparatus according to claim 1, wherein, on a display screen of library information for image recording information generated by the library generating unit, when management information on the continuous mode is specified by a user operation, display information is generated so that a respective one of plural items of image recording information in accordance with the continuous mode is selectively displayed in a form such that a “viewed” or “non-viewed” display can be identified.

9. A recording and reproducing apparatus according to claim 1, further comprising:
a reproducing unit, on a display screen of library information for image recording information generated by the library generating unit, when management information on the continuous mode is specified by a user operation, and a reproduction command is received, configured to output a reproduction signal after reproduced from information which is “non-viewed” and to be recorded earliest from among plural items of image recording information in accordance with the continuous mode.

10. A recording and reproducing apparatus according to claim 1, wherein, when reproduction of image recording information in accordance with the continuous mode is carried out, if a command for a skipping process is received from a user, the reproducing unit carries out reproduction after skipping a reproduction position, assuming that each start position of plural-round image recording information handled as the one unit of management information is defined as a chapter point.

11. A recording and reproducing method comprising:
by using a tuner unit configured to select channel and decode a broadcast signal and output picture information and a recording unit configured to record the picture information from the tuner unit into a recording region, storing given day of the week information, time information, channel selection information, and continuous mode information for repeatedly carrying out reservation image recording with respect to these items of information and handling image recording information as a series of information; and controlling the tuner unit and the recording unit based on these items of information to carry out reservation image recording; and
generating display information so as to display an image as a unit of management information even with respect to management information for plural rounds of image recording information when the management information for the image recording information recorded based on the continuous mode information is displayed as library information.

12. A recording and reproducing method according to claim 11, wherein, in the reservation image recording management, reservation image recording operations based on normal mode information which is a normal image recording mode and the continuous mode information, according to reservation information to be inputted are carried out in parallel, respectively; and
in the library generation, management information for one item of image recording information recorded based on the normal mode information is handled as a unit of management information, in response to a command for displaying a library screen, and display information is generated so as to display an image on the same screen as a unit of management information even with respect to management information for plural rounds of image recording information recorded based on the continuous mode information.

13. A recording and reproducing method according to claim 11, wherein an image is displayed as a unit of management information even with respect to management information for image recording information recorded a plurality of times based on the continuous mode information, in response to the command for displaying a library screen, and display information is generated so as to display an image together with image recording count of the image recording information.

14. A recording and reproducing method according to claim 11, wherein, when management information for image recording information recorded based on the continuous mode information is displayed as library information, display information is generated so as to display an image together with whether the image recording information is “viewed” or “non-viewed”.

15. A recording and reproducing method according to claim 11, wherein, while reservation image recording is repeatedly carried out based on same reservation information, when reservation mode information has been changed from normal mode information to the continuous mode information in the middle of the image recording, management information for image recording information after recorded is changed from the normal mode information to the continuous mode information, the management information dating back to the past, and the changed information is integrated, thereby generating display information so as to display an image as a unit of management information with respect to management information for plural items of image recording information which have been repeatedly reserved and recorded based on the same reservation information.

16. A recording and reproducing method according to claim 11, wherein plural items of image recording information recorded based on the continuous mode information are managed as a series of continuous image recording information, and the management information is edited so that a chapter point is set for the series of image recording information every time image recording is carried out.

17. A recording and reproducing method according to claim 11, wherein, on a display screen of the library information for the image recording information, when management information on the continuous mode is specified by a user operation, display information is generated so that each of plural items of image recording information in accordance with the continuous mode is selectively displayed.

18. A recording and reproducing method according to claim 11, wherein, on a display screen of the library information for the image recording information, when management information on the continuous mode is specified by a user operation, display information is generated so that each of plural items of image recording information in accordance with the continuous mode is selectively displayed in a form such that a “viewed” or “non-viewed” display can be identified.

19. A recording and reproducing method according to claim 11, wherein, on a display screen of the library information for the image recording information, when management information on the continuous mode is specified by a user operation, and a reproduction command is received, a reproduction signal is outputted after reproduced from information which is “non-viewed” and which has been recorded earliest from among plural items of image recording information in accordance with the continuous mode.

20. A recording and reproducing method according to claim 11, wherein, when reproduction of image recording information in accordance with the continuous mode is carried out, if a command for a skipping process is received from a user, reproduction is carried out after skipping a reproduction position, assuming that each start position of plural-round image recording information handled as the one unit of management information is defined as a chapter point.
